(19) United States
(12) Patent Application Publication
(10) Pub. No.: US 2009/0253452 A1
(43) Pub. Date: Oct. 8, 2009

(54) Mobile Communication System, Base Station Device, and Interference Wave Judging Method

(75) Inventor: Masanori Kato, Yokohama (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/302,720

(22) PCT Filed: May 28, 2007
(86) PCT No.: PCT/JP2007/060819

§ 371 Date: Jun. 12, 2009

(30) Foreign Application Priority Data
May 29, 2006 (JP) 2006-147630

(51) Int. Cl. H04B 7/00; H04B 1/38; H04B 17/00

(52) U.S. Cl. 455/509; 455/561; 455/67.13

(57) ABSTRACT

A base station device (10) for carrying out radio communications with a mobile station device includes: a frequency channel assigning unit (12) for assigning multiple mutually different frequency channels to the mobile station device; a communication quality information acquiring unit (13) for acquiring communication quality information indicating communication quality for each o the multiple frequency channels assigned to the mobile station device by the frequency channel assigning unit; and an interference wave existence judging unit (14) for judging whether or not an interference wave exists for each of the multiple frequency channels assigned to the mobile station device by the frequency channel assigning unit (12), on the basis of a difference in the communication quality information between the frequency channels acquired by the communication quality information acquiring unit (13).

### TECHNICAL FIELD

The present invention relates to a mobile communication system, a base station device, and an interference wave judging method for judging whether or not an interference wave exists in a mobile station device which performs radio communications.

### BACKGROUND ART

In mobile communications, there is a case where communication quality deteriorates due to influence of noise (for example, Japanese Patent Application Publication No. Hei 6-197079). In general, noise includes an interference wave that is frequency-selective noise, and while noise that is uniform noise at all frequencies.

An interference wave is mainly a transmission radio wave from another mobile station device, and exists only at a certain frequency. For this reason, when communication quality deteriorates due to an interference wave, the communication quality is improved by changing the frequency.

On the other hand, white noise exists over a wide range of frequency band, and therefore the change of frequency does not lead to the improvement of communication quality in many cases. Accordingly, in trying to improve communication quality, it is preferable to judge which of an interference wave and while noise is a factor deteriorating the communication quality.

### DISCLOSURE OF THE INVENTION

Meanwhile, in order to ascertain that communication quality deteriorates due to an interference wave, the following types of processing are considered. Specifically, the processing includes: one of checking whether or not a similar deterioration cause exists at other frequencies; and one of acquiring SNR indicating the level of only a white noise component by receiving an interference wave as a desired wave. These types of processing are so complicated that there is a need for simpler processing to ascertain that communication quality deteriorates due to an interference wave.

Thus, the present invention alma to provide a mobile communication system, a base station device and an interference wave judging method which are capable of ascertaining, through simple processing, that communication quality deteriorates due to an interference wave.

In order to achieve the above challenge, a mobile communication system according to the present invention is a mobile communication system including a mobile station device which performs radio communications, the system characterized by including: a frequency channel assigning unit configured to assign a plurality of mutually different frequency channels to the mobile station device; a communication quality information acquiring unit configured to acquire communication quality information indicating communication quality for each of the plurality of frequency channels assigned to the mobile station device by the frequency channel assigning unit; and an interference wave judging unit configured to judge whether or not an interference wave exists for each of the plurality of frequency channels assigned to the mobile station device by the frequency channel assigning unit, on the basis of a difference in the communication quality information between the frequency channels acquired by the communication quality information acquiring unit.

When a mobile station device performs communications with a base station device by using multiple frequency channels simultaneously (this type of communication mode is called frequency aggregation), communication quality in the multiple frequency channels should be the same it no frequency-selective noise (i.e., an interference wave) exists. In contrast, if an interference wave exists, it is highly possible that a difference in communication quality between these multiple frequency channels occurs.

Hence, according to the above mobile communication system, the communication quality information (to be specific, throughput, RSSI, SINR, or the like) is acquired for each of the frequency channels, and it is judged whether or not an interference wave exists on the basis of this difference. Thereby, through simple processing, it is possible to ascertain that communication quality deteriorates due to an interference wave.

Moreover, in the above mobile communication system, the mobile communication system may further comprise a plurality of mobile station devices and a base station. In this system, each of the plurality of mobile station devices performs radio communications, which are multiplexed by space division multiplexing and frequency division multiplexing, with the base station device. In addition, the interference wave judging unit may judge for each of the plurality of mobile station devices whether or not an interference wave exists for each of the plurality of frequency channels assigned by the frequency channel assigning unit. Furthermore, the mobile communication system may comprise: a combination specifying unit configured to specify a combination of a plurality of mobile station devices whose communication waves interfere with each other, on the basis of a judgment result by the interference wave judging unit; and an assignment switching unit configured to switch the assignment of frequency channels between the mobile station devices constituting the respectively different combinations, the frequency channels each having been judged as having the interference wave by the interference wave judging unit.

In radio communications multiplexed by space division multiplexing, interference of communication radio waves occurs between mobile station devices located at a close distance. According to the above mobile communication system, frequency channels are switched between mobile station devices constituting their respective combinations each composed of mobile station devices that interfere with each other. Thus, influence of an interference wave can be eliminated.

Further, in the above mobile communication system, the assignment switching unit may determine, as a target for frequency channel switching, a mobile station device having the lowest throughput among the plurality of mobile station devices constituting the combinations.

In this way, it is possible to eliminate influence of an interference wave while maintaining fairness among the mobile station devices.

Furthermore, in the mobile communication system, the assignment switching unit may determine, as a target for switching, a frequency channel having the lowest throughput of the mobile station devices among the frequency channels each having been judged as having an interference wave by the interference wave judging unit.

In this way, the total throughput of the base station device can be increased by switching the frequency channels.

In addition, a base station device according to the present invention is a base station device which performs radio communications with a mobile station device, characterized by including: a frequency channel assigning unit configured to assign a plurality of mutually different frequency channels to the mobile station device; a communication quality information acquiring unit configured to acquire communication quality information indicating communication quality for each of the plurality of frequency channels assigned to the mobile station device by the frequency channel assigning unit; and an interference wave judging unit configured to judge whether or not an interference wave exists for each of the plurality of frequency channels assigned to the mobile station device by the frequency channel assigning unit, on the basis of a difference in the communication quality information between the frequency channels acquired by the communication quality information acquiring unit.

Additionally, an interference wave judging method according to thy present invention is an interference wave judging method for judging whether or not an interference wave exists in a mobile station device which performs radio communications. The method is characterised by including: a step of assigning a plurality of mutually different frequency channels to the mobile station device; a step of acquiring communication quality information indicating communication quality for each of the plurality of frequency channels assigned in the step of assigning; and an interference wave existence judging step of judging whether or not an interference wave exists for each of the plurality of frequency channels assigned in the step of assigning, on the basis of a difference in the communication quality information between the frequency channels acquired in the step of acquiring.

### BRIEF DESCRIPTION OF THE DRAWINGS

FIG. 1 is a system configuration diagram showing a system configuration of a mobile communication system according to an embodiment of the present invention.

FIG. 2 is a block diagram showing a functional block of a base station device according to the embodiment of the present invention.

FIG. 3 is a flowchart showing a processing flow of the base station device according to the embodiment of the present invention.

FIG. 4 is a flowchart showing the processing flow of the base station device according to the embodiment of the present invention.

FIG. 5 is a flowchart showing the processing flow of the base station device according to the embodiment of the present invention.

FIG. 6 is a flowchart showing the processing flow of the base station device according to the embodiment of the present invention.

FIG. 7 is a flowchart allowing the processing flow of the base station device according to the embodiment of the present invention.

### BEST MODES FOR CARRYING OUT THE INVENTION

Embodiments of the present invention will be described with reference to the drawings.

(Schematic Configuration of Mobile Communication System)

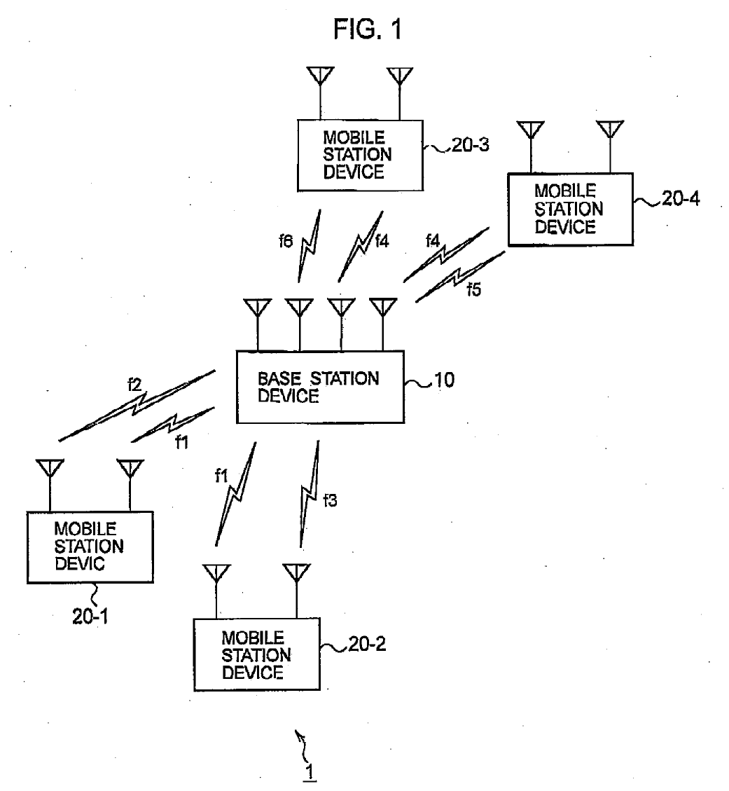

FIG. 1 is a system configuration diagram showing a system configuration of a mobile communication system 1 according to this embodiment. As shown in FIG. 1, the mobile communication system 1 includes a case station device 10 and mobile station, devices 20.

Each of the base station device 10 and the mobile station devices 20 is a computer provided with a CPU and a memory. The CPU is a processing unit for executing a program stored in the memory, and not only performs processing for controlling various parts of each device, but also implements various functions to be described below. The memory stores therein programs and data for implementing this embodiment. Moreover, the memory operates as a work memory of the CPU.

The base station device 10 includes an adaptive array antenna, and performs radio communications, which are multiplexed by space division multiplexing, with the multiple mobile station devices 20 by use of this adaptive array antenna. Hereinafter, each channel multiplexed by space division multiplexing is referred to as a spatial channel. The base station device 10 sets spatial channels for each of the mobile station devices 20 in a way that the directivity of a radio wave to be transmitted to the mobile station device 20 is set in a direction in which the mobile station device 20 exists.

The base station device 10 also performs radio communications, which axe multiplexed by frequency division multiplexing, with the multiple mobile station devices 20. Hereinafter, each channel multiplexed by frequency division multiplexing is referred to as a frequency channel. The base station 10 assigns multiple mutually different frequency channels to each of the mobile station devices 20. In this assignment, the base station device 10 assigns the same frequency channel to two or more mobile station devices 20, depending on whether or not different spatial channels can be set for the mobile station devices by the space division multiplexing.

The mobile station devices 20 each perform radio communications, which are multiplexed by space division multiplexing and frequency division multiplexing, with the base station device 10. Hereinafter, the unit of the radio communications is referred to as a communication channel.

Here, the mobile station devices 20 each include multiple antennas. One antenna of the mobile station device 20 corresponds to one communication channel. The mobile station device 20 respectively assigns the antennas multiple frequency channels assigned by the base station device 10, and thus performs communications with the base station device 10 by using a different frequency channel for each of the antennas. In other words, when attention is paid only to one mobile station device 20, the frequency channels correspond to the communication channels in one-to-one correspondence.

(Configuration of Base Station Device)

Hereinafter, a detailed description of this embodiment will be given with reference to a functional block of the base station device 10.

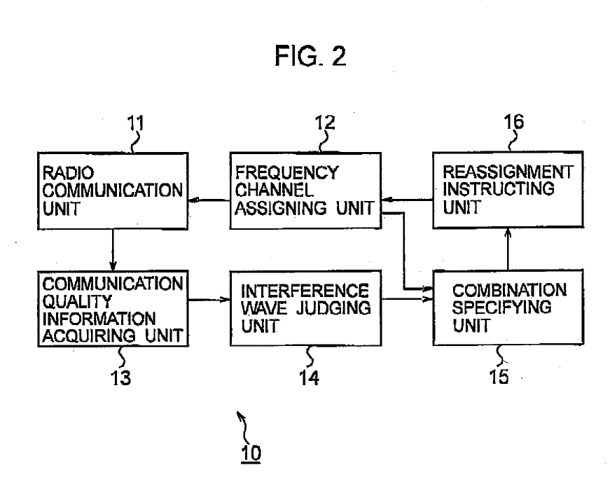

FIG. 2 is a diagram showing the functional block of the base station device 10. As shown in FIG. 2, the base station device 10 includes a radio communication unit 11, a frequency channel assigning unit 12, a communication quality information acquiring unit 13, an interference wave judging unit 14, a combination specifying unit 15, and a reassignment instructing unit 16.

The radio communication unit 11 performs radio communications with the multiple mobile station devices 20. This radio communications are started when the base station device 10 and the mobile station devices 20 transmit and receive control signals by using control channels.

By using multiple antenna elements constituting the adaptive array antenna, the radio communication unit 11 receives radio signals transmitted by each of the mobile station devices 20. The radio communication unit 11 calculates reception weight indicating a difference in amplitude and phase of each of the received radio signals between the antenna elements. Then, on the basis of the calculated reception weight, the radio communication unit 11 controls the amplitude and phase of a signal to be transmitted to the mobile station device 20. As a result, the transmitting radio wave becomes a radio wave having directivity in the direction of the mobile station device 20.

The frequency channel assigning unit 12 assigns multiple mutually different frequency channels to the mobile station devices 20 by using the control signals transmitted and received when starting radio communications with the mobile station devices 20. In this case, the frequency channel assigning unit 12 may sometimes assign the same frequency channel to two or more of the mobile station devices 20 for which space division multiplexing is possible by way of the control of the directivities by the radio communication unit 11.

In an example of FIG. 1, the frequency channel of a frequency f1 and the frequency channel of a frequency f2 are assigned to the mobile station device 20-1. The frequency channel of the frequency f1 and the frequency channel of a frequency f3 are assigned to the mobile station device 20-2. The frequency channel of a frequency f4 and the frequency channel of a frequency 6 are assigned to the mobile station device 20-3. The frequency channel of the frequency f4 and the frequency channel of a frequency f5 are assigned to the mobile station device 20-4.

In essence, multiple mutually different frequency channels are assigned to each of the mobile station devices 20. The common frequency channel (frequency f1) is assigned to the mobile station device 20-1 and the mobile station device 20-2. The common frequency channel (frequency f4) is assigned to the mobile station device 20-3 and the mobile station device 20-4.

For each of the mobile station devices 20, the communication quality information acquiring unit 13 acquires communication quality information indicating communication quality for each of the multiple frequency channels assigned to the mobile station device 20 by the frequency channel designing unit 12. As communication quality information, it is preferable to use throughput; however, signal-to-interference-and-noise ratio (SINR), received power (RSSI), or the like may also be used.

On the basis of differences in the communication quality information between the frequency channels acquired by the communication quality information acquiring unit 13, the interference wave judging unit 14 judges whether or not an interference wave exists for each of the multiple frequency channels assigned to the mobile station device 20 by the frequency channel assigning unit 12. To take a specific example, the interference wave judging unit 14 judges that there is an interference from the communication radio wave of another mobile station device 20, depending on whether or not the difference exceeds a predetermined threshold.

More specifically, if the difference is above the predetermined threshold, the interference wave judging unit 14 judges that the communication radio wave of another mobile a station device 20 interferes with the frequency channel having lower communication quality information. On the other hand, if the difference is below the predetermined threshold, the interference wave judging unit 14 judges that the communication radio wave of another mobile station device 20 does not interfere with any of the frequency channels.

For each of the multiple mobile station devices 20, the interference wave judging unit 14 judges, as described above, whether or not an interference wave exists for each of the multiple frequency channels assigned by the frequency channel assigning unit 12.

The combination specifying unit 15 specifies a combination of the multiple mobile station devices 20 whose communication radio waves interfere with each other, on the basis of a judgment result by the interference wave judging unit 14. Specifically, if the interference wave judging unit 14 judges that all of the multiple mobile station devices 20 assigned a common frequency channel with multiplexing by space division multiplexing have interferences in the common frequency channel, the combination specifying unit 15 judges that the communication radio waves of these mobile station devices 20 interfere with each other. Then, the combination specifying unit 15 specifies the combination of the mobile station devices 20 whose communication radio waves interference with each other.

A further specific description will be given, with reference to the example shown in FIG. 1. For example, assume that the interference wave judging unit 14 judges that the communication wave of another mobile station device 20 interferes with the frequency channel of the frequency f1 in either of the mobile station device 20-1 and the mobile station device 20-2. In this case, the combination specifying unit 15 specifics the combination of the mobile station device 20-1 and the mobile station device 20-2.

In contrast, assume that the interference wave judging unit 14 judges that the communication wave of another mobile station device 20 interferes with the frequency channel of the frequency f6 in the mobile station device 20-3, and also assume that the interference wave judging unit 14 judges that the communication wave of another mobile station device 20 interferes with the frequency channel of the frequency f5 in the mobile station device 20-4, for example. In this case, the combination specifying unit 15 does not specify the combination of the mobile station device 20-3 and the mobile station device 20-4. This is because the interference wave judging unit 14 judges that none of these devices receives an interference with the common frequency channel (here, the frequency f4).

The reassignment instructing unit 16 instructs the frequency channel assigning unit 12 to switch the assignment of frequency channels between the mobile station, devices 20 constituting the respectively different combinations, the frequency channels being judged as having an interference wave by the interference wave judging unit 14. In this case, the reassignment instructing unit 16 may determine, as a target for frequency channel switching, a mobile station device 20 having the lowest throughput among the multiple mobile station devices 20 constituting the combinations. Alternatively, the reassignment instructing unit 16 may determine, as a target for switching, a frequency channel having the lowest throughput of the mobile station devices 20 among the frequency channels each judged as having an interference wave by the interference wave judging unit 14.

The frequency channel assigning unit 12 changes the assignment of frequency channels in response to an instruction from the reassignment instructing unit 16.

(Operation of Base Station Device)

A description will be given in more detail again of the function of the base station device 10 described above, with reference to a processing flow of the base station device 10. Note that, in the following processing, the base station device 10 determines mobile station devices 20 (reassignment target mobile station devices) and frequency channels (reassignment target frequency channels), as targets for frequency channel switching.

In this case, the base station device 10 firstly determines one reassignment target mobile station device and one reassignment target frequency channel (called a reassignment target mobile station device A and a reassignment target frequency channel A). Next, the base station device 10 determines another reassignment target mobile station device and reassignment target frequency channel (called a reassignment target mobile station device B and a reassignment target frequency channel B) to be switched with the reassignment target mobile station device A and the reassignment target frequency channel A, respectively.

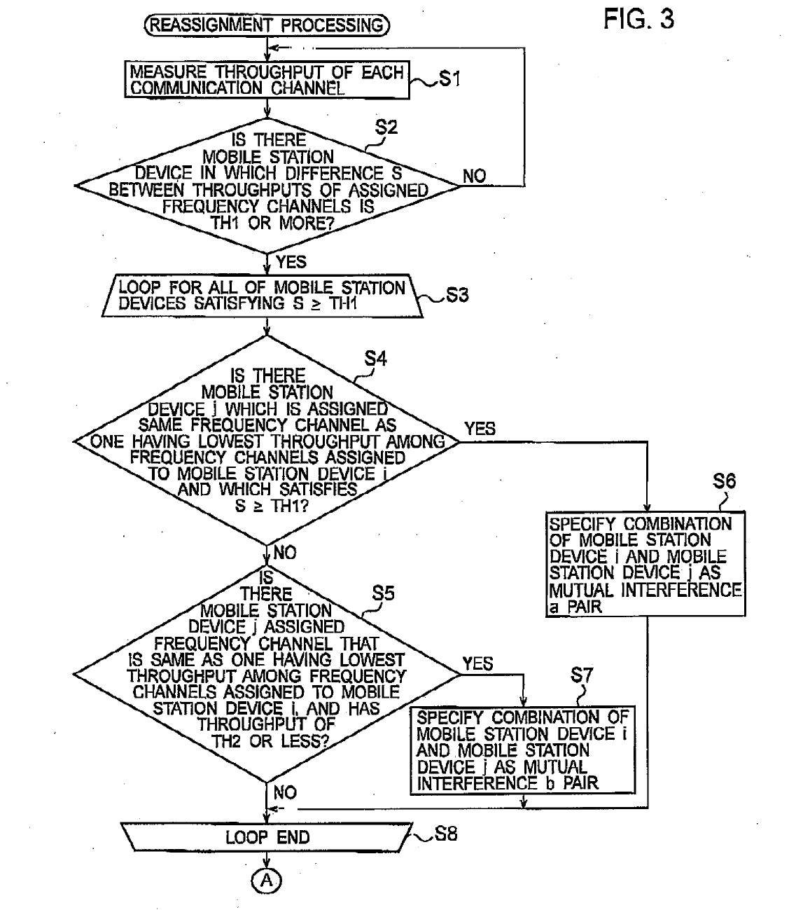

FIGS. 3 to 5 are charts showing a processing flow of the base station device 10. As shown in FIG. 3, the communication quality information acquiring unit 13 firstly measures the throughput of each communication channel (S1). Specifically, the communication quality information acquiring unit 13 measures the throughput of each frequency channel assigned to each of the mobile station devices 20.

Subsequently, the interference wave judging unit 14 judges whether or not there is a mobile station device 20 in which the difference S between the throughputs of the assigned frequency channels is equal to or larger than a predetermined threshold TH1 (S2).

The combination specifying unit 15 performs processing of S4 to S7 for all of the mobile station devices 20 having been judged to be S≧TH1 in the processing of S2 (S3 and S8). Note that, in FIG. 3, each mobile station device 20 having been judged to be S≧TH1 is called a mobile station device i.

In the processing of 54, the combination specifying unit 15 judges whether or not there is another mobile station device 20 (called a mobile station device j) which is assigned the same frequency channel as the frequency channel having the lowest throughput, among the frequency channels assigned to the mobile station device i, and which satisfies s≧TH1 (s4). If there is the mobile station j which satisfies S≧TH1, the combination specifying unit 15 specifies a combination of the mobile station device i and the mobile station device j as a mutual interference a pair (S6).

In contrast, if it is judged that there is no such mobile station device in S4, the combination specifying unit 15 then judges whether or not there is another mobile station device 20 (called a mobile station device j) assigned the frequency channel that is the same as the frequency channel having the lowest throughput among the frequency channels assigned to the mobile station device i, and that has the throughput equal to or lower than a predetermined threshold TH2 (S5). If there is the mobile station j in which the throughput of the frequency channel is equal to or lower than the predetermined threshold TH2, the combination specifying unit 15 specifies a combination of the mobile station device i and the mobile station device j as a mutual interference b pair (S7).

When the processing up to S8 is finished, the reassignment instructing unit 16 judges whether or not at least one mutual interference a pair is specified (S9). If the mutual interference a pair is specified, the reassignment instructing unit 16 specifies, as the reassignment target mobile station device A, a mobile station device which has the lowest throughput among the mobile station devices 20 constituting the mutual interference a pair (S12).

In contrast, when it is judged in S9 that no mutual interference a pair is specified, the reassignment instructing unit 16 next judges whether or not at least one mutual interference b pair is specified (S10). If the mutual interference b pair is specified, the reassignment instructing unit 16 specifies, as the reassignment target mobile station device A, a mobile station device which has the lowest throughput among the mobile station devices 20 constituting the mutual interference b pair (S13).

If it is judged also in 310 that no mutual interference b pair is specified, the reassignment instructing unit 16 next specifies, as the reassignment target mobile station device A, a mobile station device which has the lowest throughput among the mobile station devices 20 satisfying S≧TH1 (S11).

After specifying the reassignment target mobile station device A in the aforementioned manner, the reassignment instructing unit 16 specifies, as the reassignment target frequency channel A, a frequency channel which has the lowest throughput among the multiple frequency channels assigned to the reassignment target mobile station device A (S14).

The reassignment instructing unit 16, which has determined the reassignment target mobile station device A and the reassignment target frequency channel A in this manner, shifts its processing to processing for determining the reassignment target mobile station device B and the reassignment target frequency channel B.

The reassignment instructing unit 16 first judges whether or not mutual interference a pairs are specified, and whether or not the mutual interference a pairs include a mutual interference a pair not composed of the reassignment target mobile station device A (S15). If there is the mutual interference a pair not composed of the reassignment target mobile station device A, the reassignment instructing unit 16 specifies, as the reassignment target mobile station device B, a mobile station device which has the lowest throughput among the mobile station devices 20 constituting the mutual interference a pair not composed of the reassignment target mobile station device A (S17).

If it is judged “NO” in S15, the reassignment instructing unit 16 judges whether or not mutual interference b pairs are specified, and whether or not the mutual interference b pairs includes a mutual interference b pair not composed of the reassignment target mobile station device A (S16). If there is the mutual interference b pair not composed of the reassignment target mobile station device A, the reassignment instructing unit 16 specifies, as the reassignment target mobile station device B, a mobile station device which has the lowest throughput among the mobile station devices 20 constituting the mutual interference b pair not composed of the reassignment target mobile station device A (S18).

If it is judged “NO” also in 316, the reassignment instructing unit 16 judges whether or not there is a spatial channel available (S19). Specifically, the reassignment instructing unit 16 judges whether or not there is a frequency having room for multiplexing for the reassignment target mobile station device A with another mobile station device by space division multiplexing.

If it is judged that no spatial channel is available in S19, the reassignment instructing unit 16 specifies, as the reassignment target mobile station device B, a mobile station device having the lowest throughput among mobile station devices 20: in each of which the difference S between the throughputs of the assigned frequency channels is equal to or larger than the predetermined threshold TH1; and none of which is the reassignment target mobile station device A, forms the mutual interference a pair or the mutual interference b pair with the reassignment target mobile station device A, and is assigned the same frequency channel as the frequency channel assigned to both the reassignment target mobile station device A and the mobile station device 20 constituting the mutual interference a pair or the mutual interference b pair with the reassignment target mobile station device A (S20).

The reassignment instructing unit 16, which has specified the reassignment target mobile station device B in any of S17, S18 and S20, specifies, as the reassignment target frequency channel B, the frequency channel having the lowest throughput among the multiple frequency channels assigned to the reassignment target mobile station device B (S21). After specifying the reassignment target frequency channel B in this manner, the reassignment instructing unit 16 instructs the frequency channel assigning unit 12 to switch the reassignment target frequency channel A and the reassignment target frequency channel B (S22). The frequency channel assigning unit 12 changes the assignment of the frequency channels according to this instruction.

If it is judged that there is a spatial channel available in S19, the reassignment instructing unit 16 selects a frequency having the largest number of available spatial channels (S23). Specifically, the reassignment instructing unit 16 selects the frequency having the largest room for multiplexing for the reassignment target mobile station device A with another mobile station device by space division multiplexing.

If multiple frequencies each having the largest number of available spatial channels are selected in S23 (positive judgment in S24), the reassignment instructing unit 16 reselects, from the selected frequencies, a frequency channel of a frequency whose already-assigned frequency channel has the target throughput (S25).

If the multiple frequencies each having the largest number of available spatial channels are not selected in S23 (negative judgment in S24), or if the frequency is reselected in S25, the reassignment instructing unit 16 instructs the frequency channel assigning unit 12 to change the frequency of the reassignment target frequency channel A to the frequency thus selected (S26). The frequency channel assigning unit 12 changes the assignment of the frequency channels in response to this instruction.

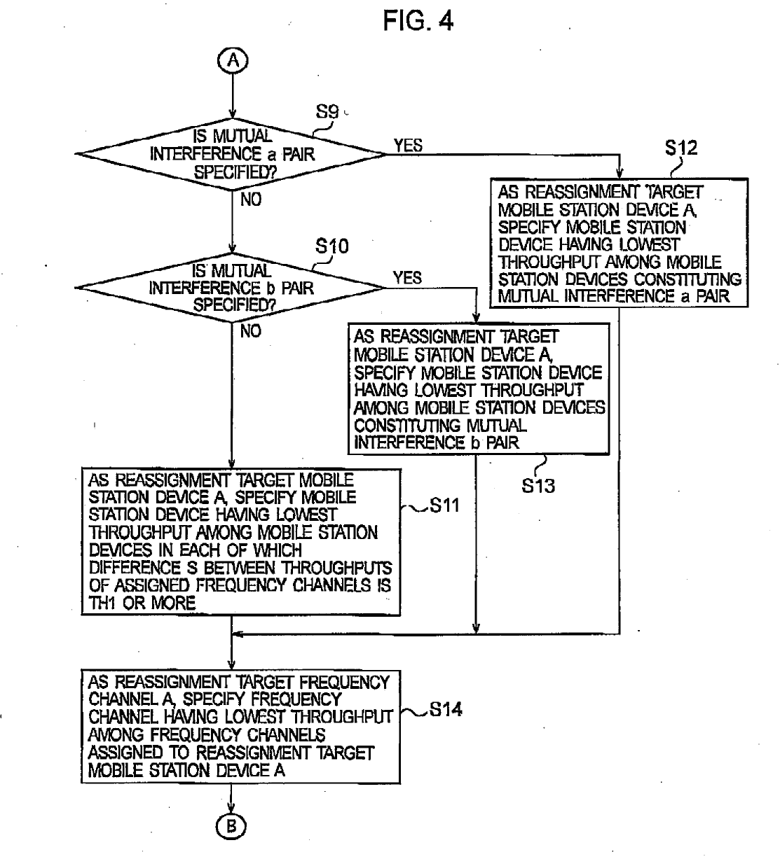

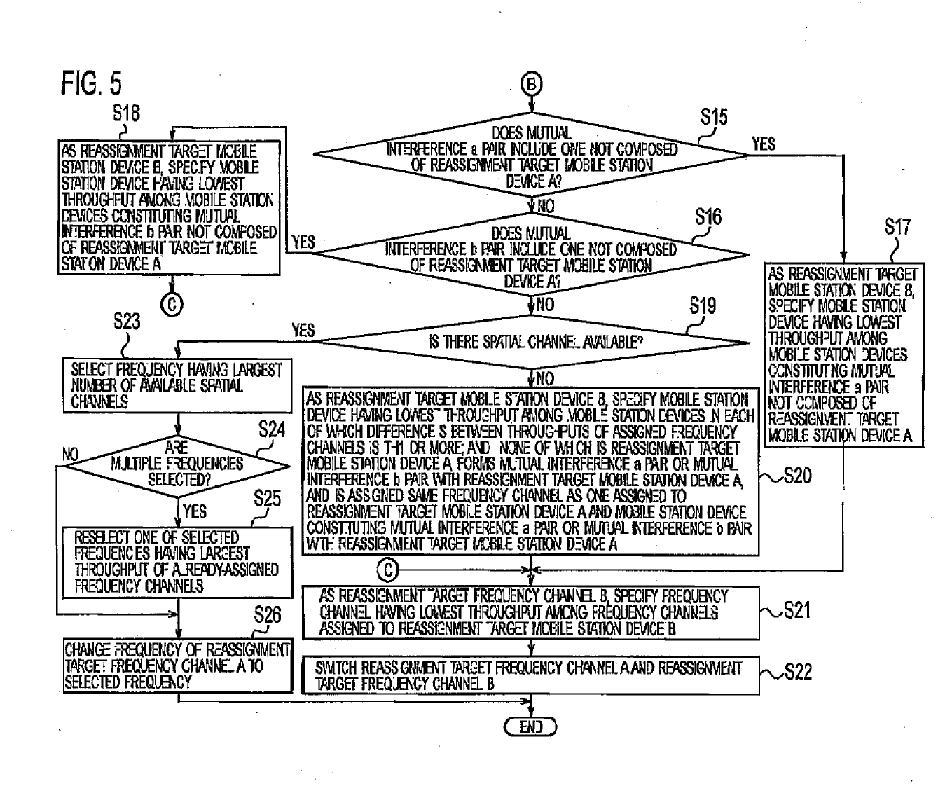

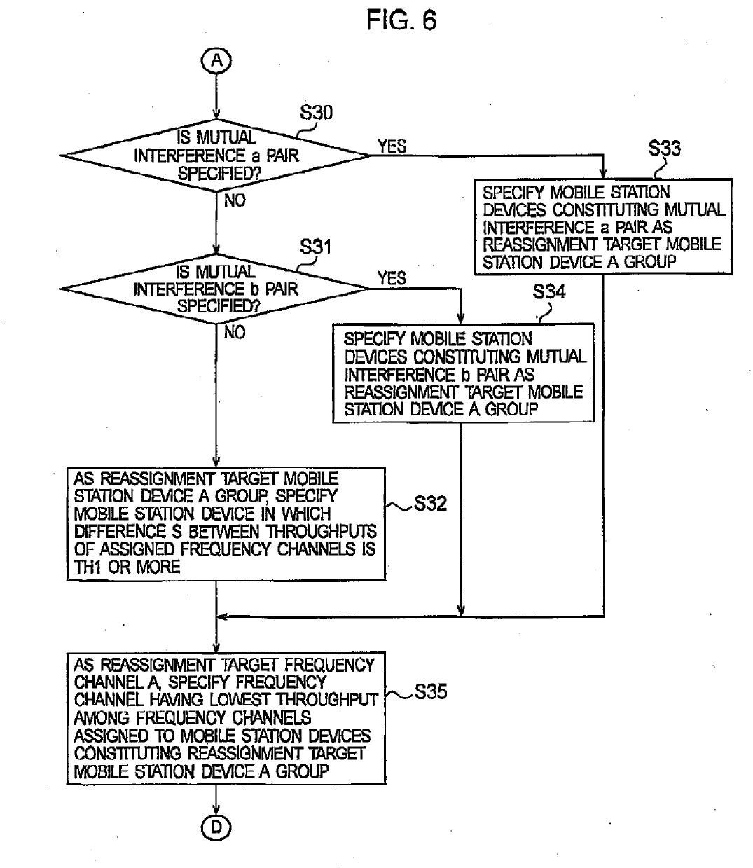

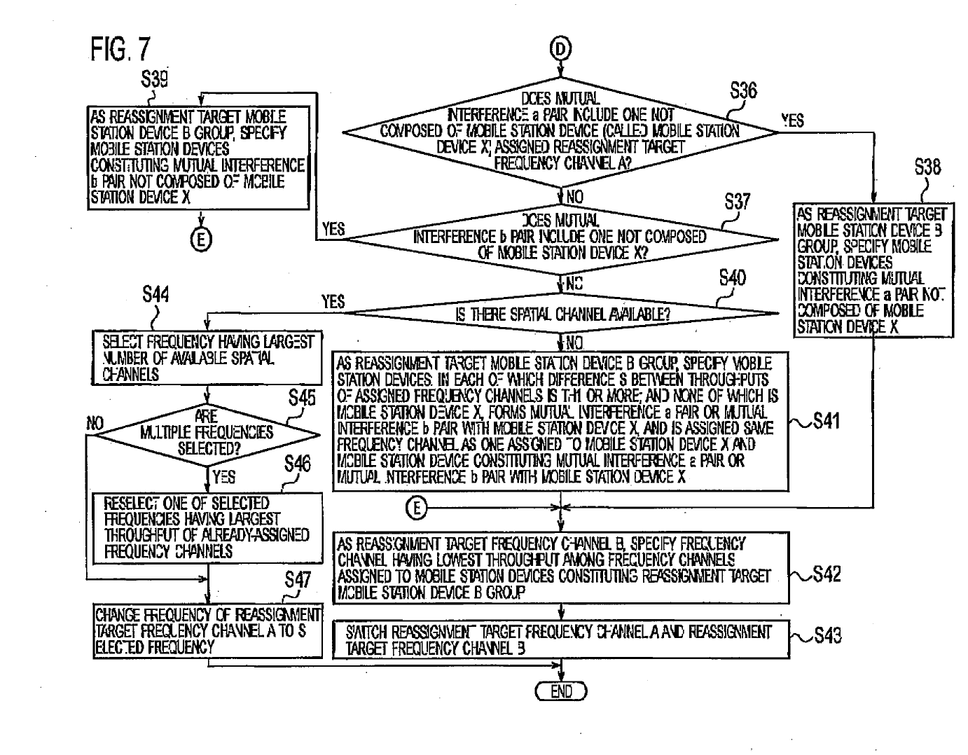

FIGS. 6 and 7 show a modified example of the processing flow shown in FIGS. 4 and 5. In this modified example, when the processing up to S8 is finished, the reassignment instructing unit 16 judges whether or not at least one mutual interference a pair is specified (330) as shown in FIG. 6. If the mutual interference a pair is specified, the reassignment instructing unit 16 specifies mobile station devices 20 constituting the mutual interference a pair as a reassignment target mobile station device A group (S33).

In contrast, if it is judged that no mutual interference a pair is specified in S30, the reassignment instructing unit 16 next judges whether or not at least one mutual interference b pair is specified (S31). If the mutual interference b pair is specified, the reassignment instructing unit 16 specifies mobile station devices 20 constituting the mutual interference b pair as the reassignment target mobile station device A group (S34).

If it is also judged in S31 that no mutual interference b pair is specified, the reassignment instructing unit 16 subsequently specifies mobile station devices 20 satisfying S≧TH1 as the reassignment target mobile station device A group (S32).

When the reassignment target mobile station device A group is specified in the manner described above, the reassignment instructing unit 16 specifies, as the reassignment target frequency channel A, a frequency channel having the lowest throughput among the multiple frequency channels assigned to the mobile station devices 20 constituting the reassignment target mobile station device A group (S35).

The reassignment instructing unit 16, which has thus determined the reassignment target frequency channel A, shifts its processing to processing for determining the reassignment target mobile station device B and the reassignment target frequency channel B.

Firstly, the reassignment instructing unit 16 judges whether or not a mutual interference a pair is specified, and whether or not the specified mutual interference a pair includes a mutual interference a pair not composed of the mobile station device (called a mobile station device X) assigned the reassignment target frequency channel A (S36). If there is the mutual interference a pair not composed of the mobile station device X, the reassignment instructing unit 16 specifies, as a reassignment target mobile station device B group, mobile station devices 20 constituting the mutual interference a pair not composed of the mobile station device x (S38).

If it is judged “NO” in S36, the reassignment instructing unit 16 then judges whether or not a mutual interference b pair is specified and whether or not the specified mutual interference b pair includes a mutual interference b pair not composed of the mobile station device X (S37). If there is the mutual interference b pair not composed of the mobile station device X, the reassignment instructing unit 16 specifies, as the reassignment target mobile station device B group, mobile station devices 20 constituting the mutual interference b pair not composed of the mobile station device X (S39).

If it is also judged “NO” in S37, the reassignment instructing unit 16 judges whether or not there is a spatial channel available (S40). Here, processing in S44 to S47 to be executed when it is judged that there is the spatial channel available is the same as that in S23 to S26 shown in FIG. 5.

If it is judged that no spatial channel is available in S40, the reassignment instructing unit 16 specifies, as the reassignment target mobile station device B group, mobile station devices 20: in each of which the difference S between throughputs of the assigned frequency channels is equal to or larger than the predetermined threshold TH1; and none of which is the mobile station device X, forms the mutual interference a pair or the mutual interference b pair with the mobile station device X, and is assigned the same frequency channel as the frequency channel assigned to both the mobile station device X and the mobile station device 20 constituting the mutual interference a pair or the mutual interference b pair with the mobile station device X (S41).

The reassignment instructing unit 16, which has specified the reassignment target mobile station device B group in any of S38, S39 and S41, specifies, as the reassignment target frequency channel B, a frequency channel having the lowest throughput among the multiple frequency channels which are assigned to the mobile station devices 20 constituting the reassignment target mobile station device B group (S42). After specifying the reassignment target frequency channel B in this manner, the reassignment instructing unit 16 instructs the frequency channel assigning unit 12 to switch the reassignment target frequency channel A and the reassignment target frequency channel B (S43). The frequency channel assigning unit 12 changes the assignment of the frequency channels according to this instruction.

### EFFECTS AND ADVANTAGES

As has been described, according to the mobile communication system 1 related to this embodiment, the base station device 10 acquires the throughput of each of multiple frequency channels assigned to a certain mobile station device 20, and judges whether or not an interference wave exists on the basis of the difference between the throughputs. Accordingly, through simple processing, the base station device 10 can ascertain that the communication quality deteriorates due to the interference wave.

Moreover, the base station device 10 switches the frequency channels between the mobile station devices constituting the respective combinations of the mobile station devices 20 that interfere with each other. Thus, influence of an interference wave can be eliminated.

Further, according to the processing described by using FIGS. 4 and 5, the base station device 10 determines as the reassignment target the mobile station device 20 having the lowest throughput. Hence, the base station device 10 can eliminate the influence of an interference wave while maintaining fairness among the mobile station devices 20.

Meanwhile, according to the processing described by using FIGS. 6 and 7, the base station device 10 determines, as the reassignment target, a frequency channel having the lowest throughput, without taking into consideration the throughputs of each mobile station device 20. Accordingly, the total throughput of the base station device 10 can be increased by switching frequency channels.

### Other Embodiments

It should be noted that the present invention is not limited to the embodiment described above. For example, in the above-described embodiment, the example where each mobile station device is provided with two antennas has been described. However, the number of antennas is not necessarily two, and the mobile station device may be provided with only one antenna, for example. In this case, when the mobile station device is provided with multiple local oscillators each capable of varying an oscillating frequency, the mobile station device can communicate with a base station device with multiple frequency channels by using only one antenna. Instead, when the mobile station device is provided with a receiver capable of handling broadband and is configured to separate a frequency at the time of performing baseband processing, the mobile station device can communicate with a base station device with multiple frequency channels by using only one antenna.

Note that, the entire contents of Japanese Patent Application No. 2006-147630 (filed on May 29, 2006) are incorporated herein by reference.

### INDUSTRIAL APPLICABILITY

The mobile communication system, the base station device, and the interference wave judging method according to the present invention can ascertain, through simple processing, that communication quality deteriorates due to an interference wave, and therefore are useful in radio communications such as mobile communications.

1. A mobile communication system including a mobile station device which performs radio communications, comprising:
a frequency channel assigning unit configured to assign a plurality of mutually different frequency channels to the mobile station device;
a communication quality information acquiring unit configured to acquire communication quality information indicating communication quality for each of the plurality of frequency channels assigned to the mobile station device by the frequency channel assigning unit; and
an interference wave existence judging unit configured to judge whether or not an interference wave exists for each of the plurality of frequency channels assigned to the mobile station device by the frequency channel assigning unit, on the basis of a difference in the communication quality information between the frequency channels acquired by the communication quality information acquiring unit.

2. The mobile communication system according to claim 1, further comprising:
a plurality of mobile station devices; and
a base station,
each of the plurality of mobile station devices performing radio communications, which are multiplexed by space division multiplexing and frequency division multiplexing, with the base station device,
the interference wave existence judging unit judging for each of the plurality of mobile station devices whether or not an interference wave exists for each of the plurality of frequency channels assigned by the frequency channel assigning unit,
the mobile communication system further comprising:
a combination specifying unit configured to specify a combination of a plurality of mobile station devices whose communication waves interfere with each other, on the basis of a judgment result by the interference wave existence judging unit; and
an assignment switching unit configured to switch the assignment of frequency channels between the mobile station devices constituting the respectively different combinations, the frequency channels each having been judged as having the interference wave by the interference wave existence judging unit.

3. The mobile communication system according to claim 2, wherein the assignment switching unit determines, as a target for frequency channel switching, a mobile station device having the lowest throughput among the plurality of mobile station devices constituting the combinations.

4. The mobile communication system according to any one of claims 2 and 3, wherein the assignment switching unit determines, as a target for switching, a frequency channel having the lowest throughput of the mobile station devices among the frequency channels each having been judged as having an interference wave by the interference wave existence judging unit.

5. A base station device which performs radio communications with a mobile station device, comprising:
a frequency channel assigning unit configured to assign a plurality of mutually different frequency channels to the mobile station device;
a communication quality information acquiring unit configured to acquire communication quality information indicating communication quality for each of the plurality of frequency channels assigned to the mobile station device by the frequency channel assigning unit; and
an interference wave existence judging unit configured to judge whether or not an interference wave exists for each of the plurality of frequency channels assigned to the mobile station device by the frequency channel assigning unit, on the basis of a difference in the communication quality information between the frequency channels acquired by the communication quality information acquiring unit.

6. An interference wave judging method for judging whether or not an interference wave exists in a mobile station device which performs radio communications, the method comprising the steps of:
assigning a plurality of mutually different frequency channels to the mobile station device;
acquiring communication quality information indicating communication quality for each of the plurality of frequency channels assigned in the step of assigning; and
judging whether or not an interference wave exists for each of the plurality of frequency channels assigned to the mobile station device in the step of assigning the frequency channels, on the basis of a difference between the frequency channels in the communication quality information acquired in the step of acquiring.
